(19) United States
(12) Patent Application Publication
(10) Pub. No.: US 2026/0073537 A1
(43) Pub. Date: Mar. 12, 2026

(54) TRANSFERRING SALIENT DEPTH PROPERTIES FROM LABELED DATA TO UNLABELED DATASETS FOR MONOCULAR DEPTH ESTIMATION

(71) Applicant: SAMSUNG ELECTRONICS CO., LTD., Suwon-si (KR)

(72) Inventors: Alexandra Dana, Tel-Aviv (IL); Amit Shomer, Tel-Aviv (IL); Tomer Peleg, Tel-Aviv (IL); Nadav Carmel, Tel-Aviv (IL); Ofer Manela, Tel-Aviv (IL)

(73) Assignee: SAMSUNG ELECTRONICS CO., LTD., Suwon-si (KR)

(21) Appl. No.: 18/882,412

(22) Filed: Sep. 11, 2024

(51) Int. Cl. G06T 7/50; G06T 7/70

(52) U.S. Cl. CPC G06T 7/50; G06T 7/70; G06T 2207/20081

(57) ABSTRACT

A method and apparatus for training a monocular depth estimation (MDE) network, including: obtaining a source dataset including a first source image and a first ground truth depth map corresponding to the first source image; obtaining a target dataset comprising a first target image and a second target image; generating an estimated first source depth map corresponding to the first source image using the MDE network; generating an estimated target depth map corresponding to the first target image using the MDE network; generating an estimated relative pose based on the first target image and the second target image using a pose network; and training the MDE network and the pose network by performing mixed supervision training, wherein the performing the mixed supervision training includes performing fully-supervised training based on the estimated first source depth map and the first ground truth depth map, and performing self-supervised training based on the estimated target depth map and the first estimated relative pose

### 1. FIELD

The present disclosure relates to monocular depth estimation, and more particularly to methods and systems for estimating depth from monocular images using a monocular depth estimation network which is trained using a mixed supervision training process based on labeled and unlabeled datasets.

### 2. DESCRIPTION OF RELATED ART

Image capture devices, for example still image cameras, moving image cameras or other electronic devices that include cameras or image sensors, may include image sensors which may be used to capture images, and image signal processors which may be used to process the captured images. Digital image processing may refer to the use of a computer to edit a digital image using an algorithm or a processing network. Image processing software may be used for image editing, robot navigation, etc.

Depth estimation is a computer vision task which may provide three-dimensional information about an object or scene, which may allow a more accurate interpretation of an object's size, shape, and location relative to other objects. Depth estimation information may be used in applications such as autonomous vehicles, augmented reality, and robotics, where objects may be accurately located and differentiated in three-dimensional space for safe and effective operation.

Some depth estimation techniques, for example single image or monocular depth estimation techniques, may require frequent or continuous fine-tuning and adjustment when new scenes are encountered. This fine-tuning and adjustment may include collecting new images, which may be difficult and time-consuming. Further, some monocular depth estimation techniques may require training using additional sensors, for example Light Detection and Ranging (LiDAR) sensors, radar sensors, or stereo cameras, which may incur additional costs and additional calibration processes. In addition, other monocular depth estimation techniques which do not require additional sensors may have limited performance, for example by being unable to provide absolute depth predictions.

### SUMMARY

Provided are systems, apparatuses, and methods for estimating depth from monocular images using a monocular depth estimation network which is trained using a mixed supervision training process based on labeled and unlabeled datasets.

Additional aspects will be set forth in part in the description which follows and, in part, will be apparent from the description, or may be learned by practice of the presented embodiments.

In accordance with an aspect of the disclosure, a method for training a monocular depth estimation (MDE) network includes: obtaining a source dataset including a first source image and a first ground truth depth map corresponding to the first source image; obtaining a target dataset including a first target image and a second target image; generating an estimated first source depth map corresponding to the first source image using the MDE network; generating an estimated target depth map corresponding to the first target image using the MDE network; generating a first estimated relative pose based on the first target image and the second target image using a pose network; and training the MDE network and the pose network by performing mixed supervision training, wherein the performing the mixed supervision training includes performing fully-supervised training based on the estimated first source depth map and the first ground truth depth map, and performing self-supervised training based on the estimated target depth map and the first estimated relative pose.

In accordance with an aspect of the disclosure, a method of performing monocular depth estimation (MDE), includes: obtaining an input image; and generating an estimated depth map by providing the input image to an MDE network, wherein a training process for the MDE network includes: obtaining a source dataset including a first source image and a first ground truth depth map corresponding to the first source image; obtaining a target dataset including a first target image and a second target image; generating an estimated first source depth map corresponding to the first source image using the MDE network; generating a first estimated relative pose based on the first target image and the second target image using a pose network; and training the MDE network and the pose network by performing mixed supervision training, wherein the performing the mixed supervision training includes performing fully-supervised training based on the estimated first source depth map and the first ground truth depth map, and performing self-supervised training based on the estimated target depth map and the first estimated relative pose.

In accordance with an aspect of the disclosure, a device for training a monocular depth estimation (MDE) network, includes: an MDE network configured to generate an estimated depth map based on an input image; a pose network configured to estimate a relative pose corresponding to one input image with respect to another input image; and a training module configured to: obtain a source dataset including a first source image and a first ground truth depth map corresponding to the first source image, obtain a target dataset including a first target image and a second target image, generate an estimated first source depth map corresponding to the first source image using the MDE network, generate an estimated target depth map corresponding to the first target image using the MDE network, generate an estimated relative pose based on the first target image and the second target image using the pose network, and train the MDE network and the pose network by performing mixed supervision training including fully-supervised training based on the estimated first source depth map and the ground truth first depth map, and self-supervised training based on the estimated target depth map and the first estimated relative pose.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram showing an example system for monocular depth estimation, according to embodiments;

FIG. 2 is a block diagram of an example system for monocular depth estimation, according to embodiments;

FIG. 3 is a diagram showing an example of fully supervised training using a labeled dataset, according to embodiments;

FIG. 4 is a diagram showing an example of a labeled dataset for depth estimation, according to embodiments;

FIG. 5 is a diagram showing an example of self-supervised training using an unlabeled dataset, according to embodiments;

FIG. 6 is a diagram showing an example of a mixed supervision training process using labeled and unlabeled datasets, according to embodiments;

FIG. 7 is a diagram illustrating an example of field of view conversion, according to embodiments; and

FIGS. 8A and 8B are flowcharts of example processes for training a monocular depth estimation network and performing monocular depth estimation, according to embodiments.

### DETAILED DESCRIPTION

Depth estimation may refer to image processing techniques that may provide three-dimensional information about an object or scene, which may allow more accurate location and differentiation of objects in a three-dimensional scene (e.g., via interpretation of a detected object's size, shape, and location relative to other objects based on depth). Depth estimation may be used in many areas related to computer vision, including video surveillance (e.g., facial recognition), image retrieval, autonomous vehicles safety systems (e.g., pedestrian detection and avoidance), etc.

As discussed above, some depth estimation techniques may involve significant data collection and/or additional measurement information from multiple sensors. Monocular depth estimation (MDE), which may for example refer to depth estimation based on single images, may involve frequent or continuous fine-tuning and adjustment when new scenes are encountered, which may be time consuming and computationally expensive. Some techniques for performing MDE may include training models using additional information from additional sensors (e.g., such as additional information from Light Detection and Ranging (LiDAR), stereo cameras, radar sensors, infrared sensors, ultrasonic sensors, time-of-flight sensors, etc.), which may enable absolute depth prediction from a single image. In embodiments, absolute depth prediction may refer to depth prediction which expresses or indicates the depth using absolute metric values (e.g., absolute measurements), in contrast with relative depth prediction, which may refer to depth prediction which expresses or indicates the depth using relative values (e.g., ratios between two depths in an image). However, these additional sensors may be associated with increased system complexity, added sensor costs, added calibration requirements, and reduced reliability.

Accordingly, embodiments of the present disclosure are directed to techniques for fine-tuning or training an MDE network for performing MDE using a mixed supervision training process based on training data which may include both labeled datasets, which may refer to images for which ground truth depth information is available, and unlabeled datasets, which may refer to images for which ground truth depth information is not available. In embodiments, the MDE network may be used in various contexts, for example in at least one of an image processing system and a video processing system.

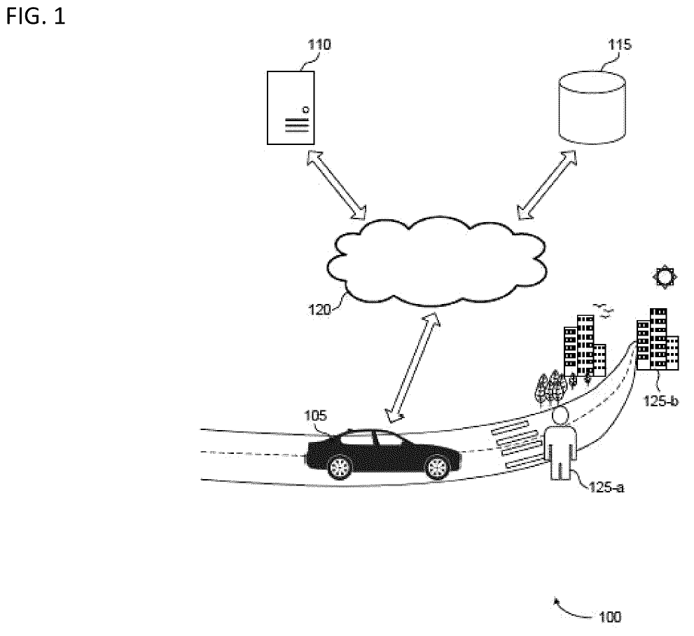

FIG. 1 shows an example of an image processing system 100 according to embodiments. As shown in FIG. 1, the image processing system 100 may include a vehicle 105, a server 110, a database 115, a network 120, and obstacles 125. The image processing system 100 is described herein as corresponding to an autonomous driving system, in which the obstacles 125 may include other vehicles, pedestrians, road signs, etc. However, embodiments are not limited thereto, and in some embodiments the MDE techniques described herein may be implemented in other systems and contexts.

In embodiments, the image processing system 100 may perform depth estimation. For example, vehicle 105 may implement object detection and depth estimation techniques to identify and distinguish between close objects and distant objects, for example to enable safe navigation in object avoidance applications, autonomous driving applications, etc. For example, relatively close objects (e.g., obstacle 125-a) may pose a greater safety concern to the vehicle 105 and may be associated with more immediate responses, while relatively distant objects (e.g., obstacle 125-b) may be safely ignored. In embodiments, these distinctions may be made by the vehicle 105 based on distances between the vehicle 105 and the objects in the environment, where such distances may be predicted or estimated based on depth estimations of obstacles 125 in images captured or received by the vehicle 105.

The vehicle 105 may use one or more sensors, for example a camera, to gather information about obstacles 125 in the environment. Sensor data may be processed to estimate the distance to each object in the field of view of the vehicle 105, for example based on a predicted or estimated depth. In some implementations, predicted or estimated depth information may be used to classify each obstacle 125 (e.g., as either close or distant based on a predefined distance threshold). Once the objects are classified (e.g., once the predicted or estimated depth information is determined), the vehicle 105 may select and prioritize a response based on the proximity of the objects. For example, the vehicle 105 may generate an alert and/or take evasive action to avoid a relatively close object (e.g., obstacle 125-a), while the vehicle 105 may ignore a relatively distant object (e.g., obstacle 125-b) that does not pose an immediate threat. Accordingly, by predicting or estimating a depth of each of the objects 125, the vehicle 105 may provide safe navigation and reduce the risk of collisions with the obstacles 125.

In embodiments, the image processing system 100 may predict or estimate distances of the obstacles 125 from the vehicle 105 using monocular images captured by the vehicle 105. A monocular image may include, or refer to, a single two-dimensional representation of a three-dimensional scene captured by a single camera. As discussed above, estimating or predicting a depth based on a single or monocular image may be referred to as MDE.

MDE may be a fundamental problem in computer vision in various contexts, for example autonomous driving, robotics, augmented reality, image enhancement, etc. Some approaches for training MDE models may include fully-supervised approaches and self-supervised approaches. For example, according to a fully-supervised approach, ground-truth depth information measured or captured by sensors such as LiDAR sensors or stereo cameras may be used to train an MDE network to generate depth predictions. As another example, according to a self-supervised structure from motion (SFM) approach, two images acquired at different times may be used to predict the relative depth in a scene and relative pose between the two images. In embodiments, the fully-supervised approach may enable the MDE network to generate absolute depth estimations, while the self-supervised SFM approach alone may be unable to do so. However, training or fine-tuning the MDE network on new scenes using the fully-supervised approach may require that corresponding depth measurements are collected when the images are captured, which may complicate the data collection setup with additional depth sensors and increasing its cost. In contrast, the self-supervised SFM approach may be performed using only a single camera.

Accordingly, embodiments described herein may be used to alleviate or eliminate the limitations of previous fully-supervised and self-supervised SFM approaches, for example by providing a method to transfer depth properties from existing datasets, which include images collected with ground truth depth information, to newly collected datasets collected without such ground truth depth information. Accordingly, embodiments may allow an MDE network to be trained, fine-tuned, or otherwise adjusted for new scenes using without the need to acquire ground truth depth information corresponding to the new scene.

For example, embodiments may use monocular images (e.g., without the use of additional active sensors and additional online measurements) to efficiently and accurately estimate distances of the obstacles 125 from the vehicle 105. For example, the vehicle 105 may use a single camera and the MDE network to generate estimated depth maps for captured monocular images. These estimated depth maps may then be used by image processing system 100 to calculate the distances of obstacles 125 in the scene.

The server 110 may provide one or more functions to users linked by a network. For example, the server 110 may include a single microprocessor board, which may include a microprocessor responsible for controlling all aspects of the server 110. In embodiments, the server 110 may use microprocessors and protocols to exchange data with other devices and/or users on a network using hypertext transfer protocol (HTTP), and simple mail transfer protocol (SMTP), although other protocols such as file transfer protocol (FTP), and simple network management protocol (SNMP) may also be used. In embodiments, the server 110 may be configured to send and receive hypertext markup language (HTML) formatted files (e.g., for displaying web pages). In embodiments, the server 110 may include at least one from among a general purpose computing device, a personal computer, a laptop computer, a mainframe computer, a super computer, and any other suitable processing apparatus.

The database 115 may be, or may include, an organized collection of data. For example, a database 115 may store data in a specified format known as a schema. The database 115 may be, or may include, at least one of a single database, a distributed database, multiple distributed databases, and an emergency backup database. In some embodiments, a controller of the database 115 may manage data storage and processing in the database 115. In some embodiments, a user may interact with the controller of the database 115, but embodiments are not limited thereto. For example, in some embodiments the controller of the database 115 may operate automatically without user interaction.

The network 120 may be, or may include, a cloud network, which may a computer network configured to provide on-demand availability of computer system resources, such as data storage and computing power. In embodiments, the network 120 may provide resources without active management by the user. The network 120 may refer to data centers which may be available to many users over the Internet. The network 120 may have functions distributed over multiple locations from central servers 110. A server 110 may be referred to as an edge server 110 if it has a direct or close connection to a user. In some embodiments, a network 120 may be limited to a single organization. In other embodiments, the network 120 may be available to many organizations. In some embodiments, a network 120 may include a multi-layer communications network including multiple edge routers and core routers. In another example, a network 120 may be based on a local collection of switches in a single physical location.

In embodiments, the vehicle 105 may be, or may include, a computing device, for example a personal computer, a laptop computer, a personal assistant, mobile device, or any other suitable processing apparatus.

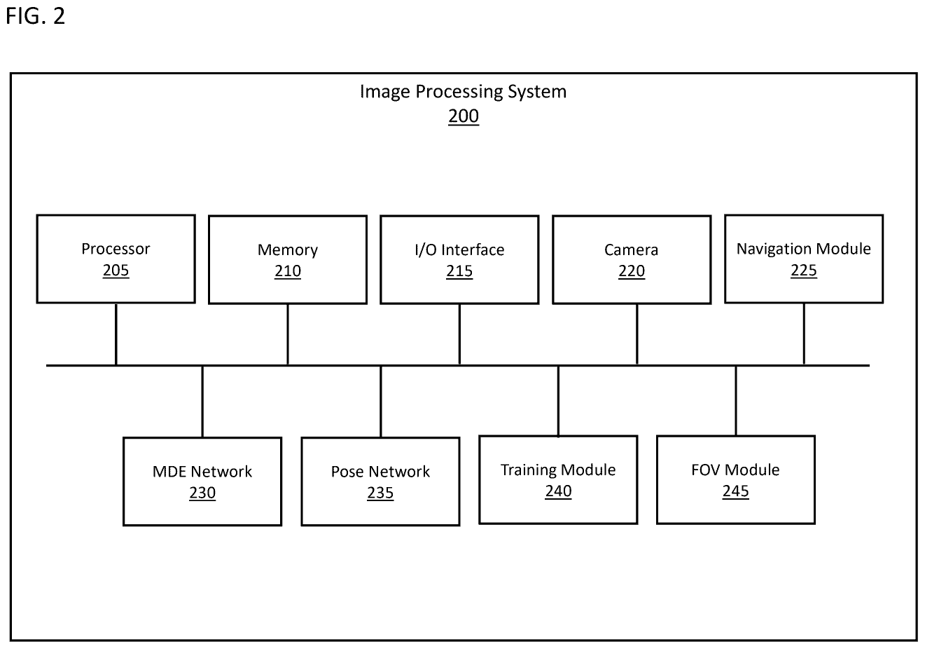

FIG. 2 is a block diagram of an example image processing system for performing monocular depth estimation, according to embodiments. As shown in FIG. 2, the image processing system 200 may include a processor 205, a memory 210, an input/output (I/O) interface 215, a camera 220, a navigation module 225, an MDE network 230, a pose network 235, a training module 240, and a field of view (FOV) module 245. In embodiments, the image processing system 200 may be included in, for example, the vehicle 105 or the server 110 discussed above. For example, the image processing system 200 may be implemented by a combination of the vehicle 105, the server 110, the database 115, and the network 120 (e.g., where components of image processing system 200, and operations performed by image processing system 200, may be distributed across the vehicle 105, server 110, database 115, and network 120).

The processor 205 may be, or may include, an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In embodiments, the processor 205 may configured to operate a memory array using a memory controller. For example, a memory controller may be integrated into the processor 205. In embodiments, the processor 205 may be configured to execute computer-readable instructions stored in a memory to perform various functions. However, embodiments are not limited thereto, and the memory controller may be included in any other element of the image processing system 200, for example in the memory 210.

The memory 210 (e.g., a memory device) may include at least one of a random access memory (RAM), a read-only memory (ROM), and a hard disk. For example, the memory 210 may include solid state memory and a hard disk drive. The memory 210 may be used to store computer-readable and computer-executable software including instructions which, when executed, may cause the processor 205 to perform various functions described herein. For example, the memory 210 may include, among other things, a basic input/output system (BIOS) which may control basic hardware or software operation such as the interaction with peripheral components or devices. In embodiments, the memory controller may operate memory cells. For example, the memory controller may include a row decoder 240, column decoder 240, or both. In some cases, memory cells within a memory 210 store information in as a logical state of the memory cells.

The I/O interface 215 may manage signals which are input from and output to the image processing system 200 and the elements included therein. The I/O interface 215 may also manage peripherals which not integrated into a device. For example, the I/O interface 215 may represent a physical connection or port to an external peripheral. In embodiments, the I/O interface 215 may utilize an operating system such as iOS®, ANDROID®, MS-DOS®, MS-WINDOWS®, OS/2®, UNIX®, LINUX®, or another operating system. In embodiments, the I/O interface 215 may represent or interact with a modem, a keyboard, a mouse, a touchscreen, or a similar device. In embodiments, the I/O interface 215 may be implemented as part of a processor 205. In embodiments, a user may interact with a device using the I/O interface 215 or using hardware components controlled by the I/O interface 215.

The image processing system 200 may include an optical instrument (e.g., the camera 220, an image sensor, etc.) for recording or capturing images, which may be stored locally, transmitted to another location, etc. For example, the camera 220 may capture visual information using one or more photosensitive elements that may be tuned for sensitivity to a visible spectrum of electromagnetic radiation. A resolution of the visual information may be measured in pixels, where each pixel may relate an independent piece of captured information. In embodiments, each pixel may correspond to one component of, for example, a two-dimensional (2D) Fourier transform of an image. Computation methods may use pixel information to reconstruct images captured by the device. In the camera 220, one or more image sensors may convert light incident on a lens of the camera 220 into an analog or digital signal. The image processing system 200 may then display an image on a display panel based on the digital signal.

A pixel (e.g., a pixel sensor) may store information about received electromagnetic radiation (e.g., light). Each pixel may include one or more photodiodes and one or more complementary metal oxide semiconductor (CMOS) transistors. A photodiode may receive a light and may output charges. The amount of output charges may be proportional to the amount of light received by the photodiode. CMOS transistors may output a voltage based on charges output from the photodiode. A level of a voltage output from the photodiode may be proportional to the amount of charges output from the photodiode. For example, the level of the voltage output from a photodiode may be proportional to the amount of light received by the photodiode.

The navigation module 225 may provide navigation information, for example guidance and direction, to an operator of a vehicle, for example the vehicle 105. For example, the navigation module 225 may include a global positioning system (GPS) receiver, digital maps, a display screen, obstacle detection and avoidance, etc. In embodiments, the navigation module 225 may determine a location of the vehicle 105, and digital maps may be used to generate routing information and display a current location and an intended route. In embodiments, the navigation module 225 may provide real-time updates on traffic conditions, estimated time of arrival, alternative routes, etc. The navigation module 225 may also include features such as voice-activated control, points of interest, and speed limit warnings.

The MDE network 230 may generate an estimated depth map based on an input image. For example, at a training time or during a training process, the MDE network 230 may generate estimated depth maps based on training images, and at an inference time after the MDE network 230 is trained, the trained MDE network 230 may generate estimated depth maps based on input images, for example images captured by the camera 220. In embodiments, an estimated depth map may represent the distance (e.g., relative distance) of one or more objects in a scene included in the input image captured by the camera 220. The MDE network 230 may implement techniques (e.g., such as computer vision techniques, machine learning techniques, etc.) to analyze the input image and predict a depth of each pixel in the image, the depth or distance of one or more objects in the scene, etc. This estimated depth information, for example included in the estimated depth map, may be used for various image processing tasks, such as 3D reconstruction, object recognition, obstacle identification and avoidance, scene segmentation, etc. For example, in some embodiments the navigation module 225 may generate navigation information based on the estimated depth information.

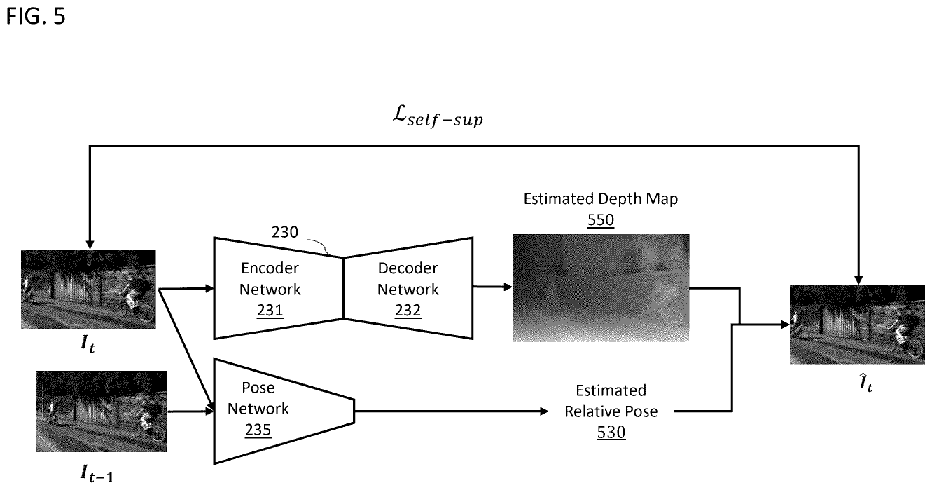

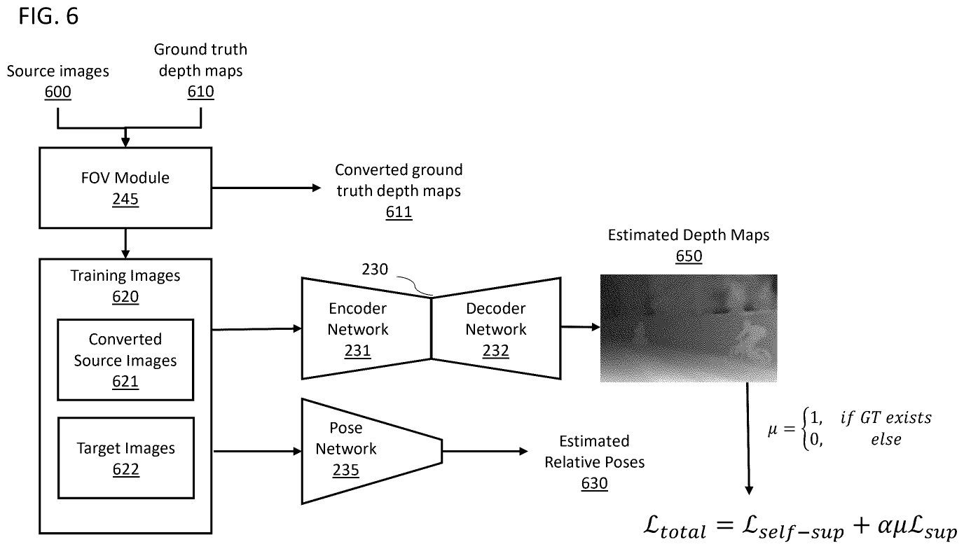

The pose network 235 may estimate or predict a relative pose between two monocular images, for example a monocular image collected at a time t and another monocular image collected at a time t−1 (or t+1). For example, in embodiments, this relative pose may be expressed as a translation matrix G between an image Iₜ and an image Iₜ₋₁ (or an image Iₜ₊₁). In embodiments, this translation matrix G may be used during a training process for the MDE network 230, examples of which are described below with respect to FIGS. 5 and 6.

The training module 240 may be configured to train machine learning, artificial intelligence, and/or neural network architectures included in the image processing system 200, for example the MDE network 230 and the pose network 235. In embodiments, the image processing system 200 may implement image processing networks to perform specialized tasks. For example, at least one of machine learning, artificial intelligence, and neural network processing may be implanted for various imaging and computer vision applications. A neural network may refer to a type of computer algorithm that is capable of learning specific patterns without being explicitly programmed, but through iterations over known data. A neural network may refer to a cognitive model that includes input nodes, hidden nodes, and output nodes. Nodes in the network may have an activation function that computes whether the node is activated based on the output of previous nodes. Training the system may involve supplying values for the inputs, and modifying edge weights and activation functions (algorithmically or randomly) until the result closely approximates a set of desired outputs.

An artificial neural network (ANN) may refer to a hardware or a software component that includes a number of connected nodes (i.e., artificial neurons), which may loosely correspond to the neurons in a human brain. Each connection, or edge, may transmit a signal from one node to another (similar to the physical synapses in a brain). When a node receives a signal, the node may process the signal and then transmit the processed signal to other connected nodes. In embodiments, the signals between nodes may include real numbers, and the output of each node may be computed by a function of the sum of its inputs. In embodiments, the nodes may determine their outputs using other mathematical algorithms (e.g., selecting the max from the inputs as the output) or any other suitable algorithm for activating the node. Each node and edge may be associated with one or more node weights which may be used to determine how the signal is processed and transmitted.

During a training process, these weights may be adjusted, for example by the training module 240, to improve the accuracy of the result (i.e., by minimizing a loss function which corresponds in some way to the difference between the current result and the target result). The weight of an edge increases or decreases the strength of the signal transmitted between nodes. In embodiments, nodes may have a threshold below which a signal is not transmitted at all. In some embodiments, the nodes may be aggregated into layers, and different layers may perform different transformations on their inputs. The initial layer may be referred to as the input layer, and the last layer is known as the output layer. In some embodiments, signals may traverse certain layers multiple times.

A convolutional neural network (CNN) may refer to a class of neural networks that may be used in computer vision or image classification systems. In embodiments, a CNN may enable processing of digital images with minimal pre-processing. A CNN may be characterized by the use of convolutional (or cross-correlational) hidden layers. These layers may apply a convolution operation to the input before signaling the result to the next layer. Each convolutional node may process data for a limited field of input, which may be referred to as the receptive field. During a forward pass of the CNN, filters at each layer may be convolved across the input volume, computing the dot product between the filter and the input. During the training process, the filters may be modified so that they activate when they detect a particular feature within the input. In embodiments, the MDE network 230 and the pose network 235 may be, or may include, one or more image processing networks, for example one or more ANNs, CNNs, etc., which may be trained using the training module 240.

In embodiments, the training module 240 may obtain training data including at least one source image that is based on source intrinsic parameters. In some examples, the training module 240 may generate a converted source image based on the source image, where the converted source image is generated based on the target intrinsic parameters. For example, the training module 240 may train the MDE network 230 to generate an estimated depth map for a monocular image that is based on the target intrinsic parameters, where the MDE network 230 is trained using at least one converted source image. In embodiments, the source image may be obtained from a source camera, and the source intrinsic parameters may correspond to a focal length and a sensor size of the source camera. In embodiments, training module 240 may obtain ground truth depth information for the source image, for example a ground truth depth map corresponding to the source image. In embodiments, training module 240 may convert the ground truth depth information to correspond to the converted source image based on the target intrinsic parameters. In some embodiments, the source image and the ground truth depth information may be converted using the FOV module 245. In embodiments, the training module 240 may obtain additional training data using a target camera, where the target intrinsic parameters correspond to a focal length and a sensor size of the target camera. In embodiments, the target camera may correspond to the camera 220 include in the image processing system 200.

Embodiments of the present disclosure may enable efficient implementation of accurate depth estimation algorithms by monocular imaging systems. As such, the image processing system 200 may include, or enable, single sensor systems without additional sensor information, power limited (e.g., battery-operated) depth estimation systems, depth estimation systems with area-limited system-on-chips (SOCs), etc.

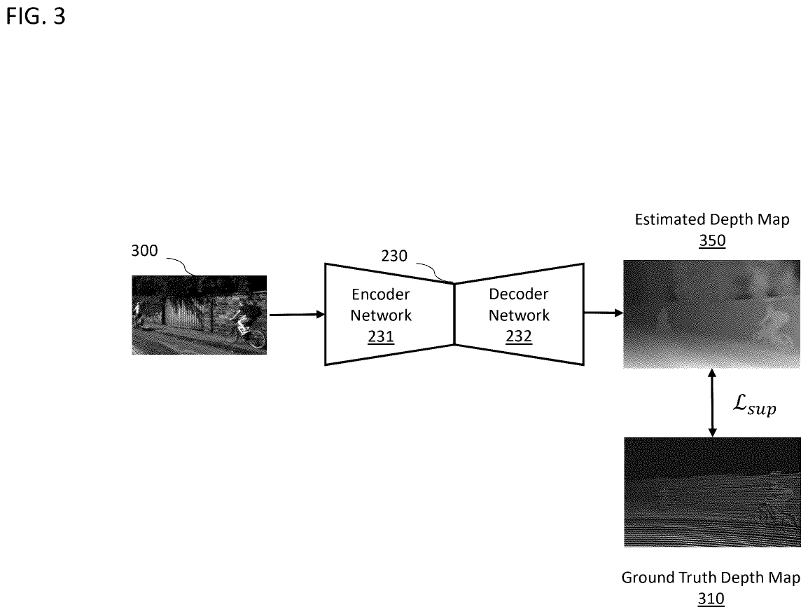

FIG. 3 is a diagram showing an example of a fully-supervised training process using a labeled dataset, according to embodiments. In embodiments, the fully-supervised training process may be performed by the training module 240. As shown in FIG. 3, the MDE network 230 may include an encoder network 231 and a decoder network 232.

The encoder network 231 may include, or refer to, a device or system that transforms information from one format or representation to another. In some examples, the encoder network 231 may map input data into a compact and more efficient representation (e.g., through a series of mathematical operations). The encoded data may be used for various purposes, such as data compression, transmission or storage, signal processing, and feature extraction. For example, the encoder 310 may be implemented using MobileNet_v2 for feature extraction, but embodiments are not limited to thereto. The decoder network 232 may include, or refer to, a device or system that transforms encoded information back into an original format or representation. For example, the decoder network 232 may receive as input the representation created by the encoder network 231, and may transform the representation into a different (e.g., original) format. In embodiments, the decoder network 232 may play a complementary role to the encoder network 231, and the decoder network 232 may be used to recover information from the encoded data.

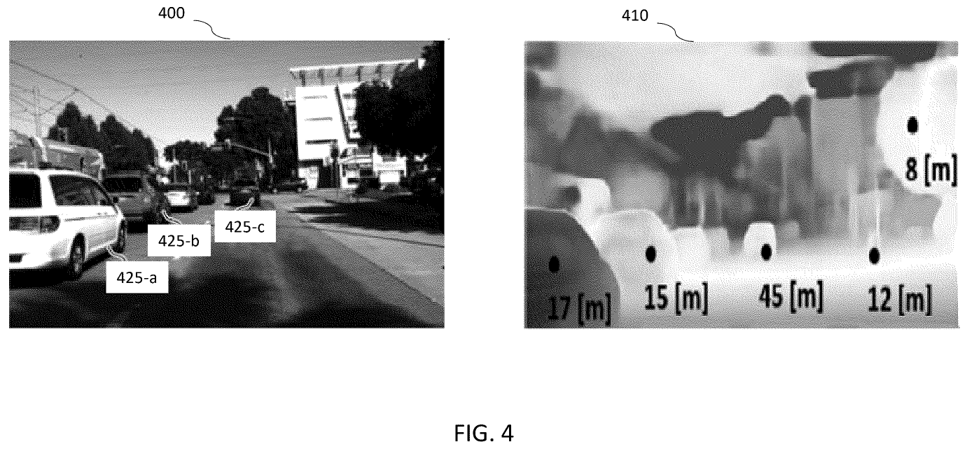

During the fully-supervised training process, the MDE network 230 may receive training images which include a monocular source image 300 from a labeled dataset. In addition, the labeled dataset may include a ground truth depth map 310 corresponding to the source image 300. An example of the labeled dataset is provided below with reference to FIG. 4.

The encoder network 231 may encode the source image 300 to obtain an image representation, and the decoder network 232 may decode the image representation to obtain an estimated depth map 350. To perform the fully-supervised training process, the training module 240 may calculate a fully-supervised loss [symbol] ₛᵤₚ based on the estimated depth map 350 and the ground truth depth map 310, and may adjust parameters of the MDE network 230 in order to minimize this loss. In embodiments, the fully-supervised loss [symbol] ₛᵤₚ may be calculated based on at least one of an L₁ loss, an L₂ loss, and an L_{surface-normals} loss, according to one or more of Equation 1, Equation 2, and Equation 3 below, but embodiments are not limited thereto:

$${L}_{1} = {\sum }_{i = 1}^{n} \vert {D}_{G T} - {D}_{p r e d} \vert = ‖ {D}_{G T} - {D}_{p r e d} ‖ \qquad Equation 1$$

$${L}_{1} = {\sum }_{i = 1}^{n} {\vert {D}_{G T} - {D}_{p r e d} \vert}^{2} = {‖ {D}_{G T} - {D}_{p r e d} ‖}_{2}^{2} \qquad Equation 2$$

$${L}_{s u r f ace - normals} = \frac{1}{2 p} {\sum }_{p ∈ D} 1 - \frac{\hat{n} \cdot n}{‖ \hat{n} ‖ ‖ n ‖} \qquad Equation 3$$

In Equation 1, Equation 2, and Equation 3 above, D_{GT} may denote a ground truth depth, for example corresponding to the ground truth depth map 310, D_{pred} may denote a predicted depth, for example corresponding to the estimated depth map 350, n may denote a surface normal vector of the ground truth depth map 310, \hat{n} may denote a surface normal vector of the estimated depth map 350, and i and p may be indexes.

FIG. 4 is a diagram showing an example of a labeled dataset for depth estimation, according to embodiments. As can be seen in FIG. 4, a source image 400 may include obstacles 425-a, 425-b, and 425-c with known ground truth information indicated by ground truth depth map 410 corresponding to the source image 400. In embodiments, the source image 300 may correspond to the source image 300, the ground truth depth map 410 may correspond to the ground truth depth map 410, and the obstacles 425-a, 425-b, and 425-c may correspond to the obstacles 125 discussed above, but embodiments are not limited thereto.

As shown in FIG. 4, the obstacle 425-a may have a known ground truth distance of 17 m indicated in the ground truth depth map 410, the obstacle 425-b may have a known ground truth distance of 15 m indicated in the ground truth depth map 410; and the obstacle 425-c may have a known ground truth distance of 45 m indicated in the ground truth depth map 410.

In some examples, the source image 400 may be included in source images from existing datasets, images captured by one or more sensors external to the image processing system, etc. For example, source image 400 may be included in a Karlsruhe Institute of Technology and Toyota Technological Institute (KITTI) dataset, a virtual KITTI (vKITTI) dataset, a Driver Dense Depth for Autonomous Driving (DDAD) dataset, etc. In some aspects, the source image 400 may be taken from a dataset that is collected from different cities, and therefore contain different structures and textures). Accordingly, datasets including source images such as the source images 400 and the ground truth depth map 410 may be used for training and fine tuning.

As discussed above, the fully-supervised training process may have a benefit in that it may produce an accurate MDE 230 which is capable of providing absolute depth estimations. However, the fully-supervised training process may require training data which is using additional sensors, for example LiDAR sensors, radar sensors, or stereo cameras, which may incur additional costs and additional calibration processes, and therefore it may be difficult to perform the fully-supervised training process for a target images corresponding to a new scene.

FIG. 5 is a diagram showing an example of a self-supervised training process using an unlabeled dataset, according to embodiments. During the self-supervised training process, the MDE network 230 may be trained jointly with the pose network 235.

For example, the MDE network 230 may receive training images which include a monocular image Iₜ corresponding to a time t, and may generate an estimated depth map 550 based on the image Iₜ image. The pose network 235 may receive the image Iₜ and a monocular image Iₜ₋₁ corresponding to a time t−1 (or a monocular image Iₜ₊₁ corresponding to a time t+1), and may generate an estimated relative pose 530 between the two images. The training module 240 may re-project the image Iₜ₋₁ to a position of the camera at the time t using Equation 4 below:

$${p}_{t - 1} ∼ K {t \to t - 1}_{} {D}_{t} {K}^{- 1} {p}_{t} \qquad Equation 4$$

In Equation 4 above, [symbol] _{(t)→t-1} may denote an estimated transition matrix between the image Iₜ₋₁ and the image Iₜ, where R indicates rotation matrix and T indicates a translation matrix, K may denote an intrinsics matrix of the camera used to capture the images, for example the camera 220, \hat{D}ₜ may denote an estimated depth obtained from the estimated depth map 550. In addition, p may denote a sample grid of an image, and pₜ₋₁ may denote the location of pixels in the image Iₜ₋₁. The obtained grid pₜ₋₁ may then be used to sample the image Iₜ₋₁, resulting in the projected image Îₜ corresponding to the time t. In embodiments, the projected image Îₜ may be an estimated image which corresponds to the image Iₜ.

To perform the self-supervised training process, the training module 240 may calculate a self-supervised loss [symbol] _{self-sup} based on the input image Iₜ and the estimated input image Ît, and may adjust parameters of the MDE network 230 and the pose network 235 in order to minimize this loss. In embodiments, the self-supervised loss [symbol] _{self-sup} may be calculated according to Equation 5 below, but embodiments are not limited thereto:

$${L}_{s elf - sup} ( {I}_{t} , {\hat{I}}_{t} ) = α \frac{1 - SSIM ( {I}_{t} , {\hat{I}}_{t} )}{2} + ( 1 - α ) ‖ {I}_{c} - {\hat{I}}_{t} ‖ \qquad Equation 5$$

In Equation 5 above, SSIM may denote a structural similarity index, and a may denote a balance coefficient between L1 (e.g., mean absolute error (MAE)) and SSIM.

Although an example is provided above in which the self-supervised training is performed based on images which are consecutive (e.g., images corresponding to a time t and a time t+1, or images corresponding to a time t−1 and a time t), embodiments are not limited thereto. For example, in some embodiments there may be intervening images or frames between the two images. For example, in some embodiments the self-supervised training may be performed based on images corresponding to a time t and a time t+2, or images corresponding to a time t and a time t+3, and so on.

As discussed above, the self-supervised training process may have a benefit in that it may be performed on unlabeled training data, for example training images for which ground-truth depth information such as ground-truth depth maps are not available. However, an MDE 230 trained based on the self-supervised training process alone may be unable to provide absolute depth estimations or sharp-edged depth maps.

Therefore, embodiments of the present disclosure may relate to a mixed supervision training process which may be performed on a combination of labeled and unlabeled training data.

FIG. 6 is a diagram showing an example of mixed supervision training process using a combination of labeled and unlabeled datasets, according to embodiments. As shown in FIG. 6, the MDE network 230 and the pose network 235 may be jointly trained based on source images 600 (at least some of which may correspond to ground truth depth maps 610) and further based on target images 622. In embodiments, the source images 600 and the ground truth depth maps 610 may correspond to a labeled dataset, and the target images 622 may correspond to an unlabeled dataset, but embodiments are not limited thereto . . . .

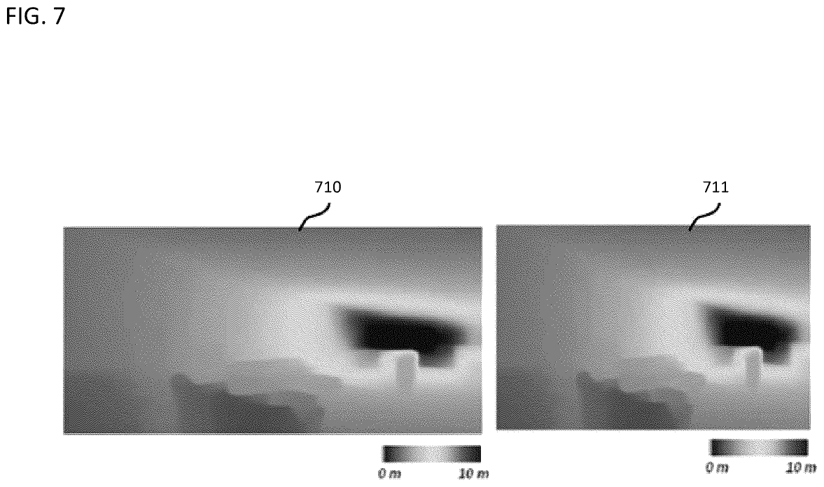

In some embodiments, the training images used to train the MDE network 230 and the pose network 235 may include both source monocular images in a source domain (e.g., the source images 600), and target monocular images in a target domain (e.g., the target images 622). For example, the target domain may include, or refer to, a domain of an image processing system (e.g., a domain of a camera in an image processing system, where the target domain may be based at least in part on target intrinsic parameters of the camera in the image processing system). For example, the target domain may include, or refer to, a new domain environment for fine-tuning or training the MDE network 230. In embodiments, the target domain may correspond to the camera 220 used by the image processing system 200 to obtain monocular images (e.g., where the target domain may correspond to a focal length of the camera 220, a sensor size of the camera 220, a field of view of the monocular image captured by the camera 220, etc.). The source domain may include, or refer to, an environment for which both monocular images and ground truth depth information from one or more additional sensors (e.g., LiDAR, radar, stereo camera, etc.) were collected to enable absolute depth estimation. In embodiments, the source domain may include an environment in which a source image is obtained (e.g., from a source camera), where the source domain may be based at least in part on source intrinsic parameters of a source camera, which may be external to the image processing system 200. In embodiments, at least one of the training module 240 and the FOV module 245 may be used to convert source images and ground truth depth maps corresponding to the source domain into converted source images corresponding to the target domain (e.g., converted source images 621) and converted ground truth depth maps corresponding to the target domain (e.g., converted ground truth depth maps 611), for example by converting a FOV of the source images to match a FOV of the target images. An example of this FOV conversion is described below with reference to FIG. 7.

FIG. 7 is a diagram illustrating an example of FOV conversion, according to embodiments. As shown in FIG. 7, a ground truth depth representation 710, which may be for example a ground truth depth map in the source domain, may be converted, along with the corresponding source image, to a converted ground truth depth representation 711, which may be for example a ground truth depth map in the target domain. For example, the converted ground truth depth representation 711 may be aligned to a target field of view corresponding to the target domain, such that the converted ground truth depth representation 711 may be converted to match the target intrinsic parameters. In embodiments, the ground truth depth representation 710 may correspond to ground truth depth map 610, and the converted ground truth depth representation 711 may correspond to the converted ground truth depth map 611, but embodiments are not limited thereto.

Training an MDE network on images collected using different camera intrinsic parameters (real or synthetic) may introduce significant geometrical differences. However, some datasets for autonomous driving (e.g., KITTI, DDAD, etc.) may be collected using different source cameras (e.g., which thus may have different source intrinsic parameters and different source extrinsic parameters). In some cases, camera heights associated with source images may be relatively similar (e.g., due to the nature of how the data is collected for autonomous driving datasets), and small differences in camera heights may be compensated for by the network (e.g., given different road slopes). However, source camera intrinsic parameters may significantly differ, which may impact FOV properties. To enable training on mixed batches of images from two datasets of source images, without breaking geometrical consistency, embodiments may convert the domain of the source images in order to align the FOV of the source images to the FOV of the target images. For example, the FOV of a camera may be expressed according to Equation 6 below:

$$∠ \frac{F O V}{2} = atan ( \frac{w}{2 f} ) \qquad ( Equation 6 )$$

In Equation 6 above, f may denote the focal length of the camera in pixel units and w may denote the width of the image. The focal length of the camera and the image width in the target domain may be represented as f_{T} and w_{T}, respectively. The focal length of the camera of the source domain may be represented as f_{S}. To convert the FOV of the source image, the image width w_{S} may be converted into w_{S→T} such that a converted source FOV is equal to the target FOV. For example, using Equation 6, Equation 7 below may be obtained:

$$∠ \frac{F O {V}_{T}}{2} = atan ( \frac{{w}_{T}}{2 {f}_{T}} ) = atan ( \frac{{w}_{S \to T}}{2 {f}_{S}} ) \qquad ( Equation 7 )$$

Equation 7 may further result in Equation 8 below:

$${w}_{S \to T} = {w}_{T} \frac{{f}_{S}}{{f}_{T}} \qquad ( Equation 8 )$$

Equation 8 may be used to determine the width of the crop taken from the source images. The height of the crop may then be determined according to the target image aspect ratio. Eventually the image crop may be resized using, for example, a bilinear interpolation to the target image size to enable mixed batches.

When correcting images from both domains to a single FOV, mixed training on both datasets may be possible, and may be able to compensate for domain gaps. Furthermore, such property may be demonstrated when mixing different datasets which were collected using different camera intrinsics (e.g., intrinsic parameters), for example when mixing real datasets with other real datasets, or when mixing synthetic datasets with real datasets. Accordingly, embodiments may be implemented using various real and synthetic source datasets.

Returning to FIG. 6, during the mixed supervision training process, the FOV module 245 may receive source images 600 and corresponding ground truth depth maps 610, which may correspond to the source domain, and may generate converted source images 621 and converted ground truth depth maps 611, which may correspond to the target domain. In embodiments, the source images 600 may correspond to the source images 300 and 400 discussed above, and the ground truth depth maps 610 may correspond to the ground truth depth maps 310 and 410 discussed above, but embodiments are not limited thereto.

The MDE network 230 may receive training images 620, which may include the converted source images 621, as well as target images 622 which may correspond to the target domain, and may generate estimated depth maps 650. The pose network 235 may receive the training images 620, and may generate estimated relative poses 630.

The training module 240 may calculate a self-supervised loss [symbol] _{self-sup} based on the estimated relative poses 630 and the estimated depth maps 650. For example, the training module 240 may generate a projected image corresponding to each training image 620 by re-projecting another training image 620 based on an estimated relative pose 630 and an estimated depth map 650, and may calculate the self-supervised loss [symbol] _{self-sup} based on the projected image, as discussed above with reference to FIG. 5. In addition, for training images 620 for which converted ground truth depth maps 611 are available, the training module 240 may calculate a fully-supervised loss [symbol] ₛᵤₚ based on the estimated depth maps 650 and the converted ground truth depth maps 611.

In embodiments, the training module 240 may calculate an overall loss [symbol] ₜₒₜₐₗ based on self-supervised loss [symbol] _{self-sup} and the fully-supervised loss [symbol] ₛᵤₚ. For example, the overall loss [symbol] ₜₒₜₐₗ may be calculated according to Equation 9 below:

$${ℒ}_{total} = {ℒ}_{s elf - sup} + {αμℒ}_{sup} \qquad ( Equation 9 )$$

In Equation 9, above, μ may be set equal to one (“1”) for training images 620 for which corresponding converted ground truth depth maps 611 are available, and may be set equal to zero (“0”) otherwise. As a result, the overall loss [symbol] ₜₒₜₐₗ may be calculated based on both the self-supervised loss [symbol] _{self-sup} and the fully-supervised loss [symbol] ₛᵤₚ for training images 620 with corresponding converted ground truth depth maps 611, and may be calculated based on only the self-supervised loss [symbol] _{self-sup} for training images 620 for which the ground truth depth information is unknown. For example, in some embodiments, the overall loss [symbol] ₜₒₜₐₗ may be calculated based on the self-supervised loss [symbol] _{self-sup} corresponding to the target images 622, and based on both the self-supervised loss [symbol] _{self-sup} and the fully-supervised loss [symbol] ₛᵤₚ corresponding to the converted source images 621 (or the source images 600), but embodiments are not limited thereto.

Therefore, the mixed supervision training process according to embodiments may be performed using a combination of a labeled dataset and an unlabeled dataset. For example, if the MDE network 230 is originally trained using source images from a labeled dataset, the mixed supervision training process may allow the MDE network 230 to be fine-tuned for a new target domain for which only target images from an unlabeled dataset are available. For example, the mixed supervision training process may allow depth properties, such as accurate predictions around object edges (e.g., sharp-edged depth maps) and absolute depth predictions, to be transferred from the labeled dataset to the unlabeled dataset depth predictions, which may improve an accuracy of the MDE network 230. For example, the mixed supervision training may be used to train the MDE network 230 to predict depth properties of the target domain based on depth properties of the source domain. As a result, after the mixed supervision training is performed, the depth estimation model may be capable of generating absolute depth predictions based on an input image from the target domain by learning depth properties of the source domain. According to some embodiments, the mixed supervision training process according to embodiments may be performed using datasets which are captured using different sensors, for example cameras which have different intrinsic properties, and may be performed using real datasets, synthetic datasets, or a combination thereof.

Accordingly, embodiments may provide techniques for training and/or fine-tuning an MDE network, for example the MDE network 230, using: (A) monocular images from a new domain and (B) existing absolute depth measurements (e.g., which may be previously collected, collected by sensors external to the image processing system 200, previously available to the image processing system 200 from existing datasets, etc.). The described depth estimation architectures and depth estimation techniques may be implemented for generating estimated depth information and estimated depth maps based on monocular images without using additional online measurements, without using additional calibrations, etc.

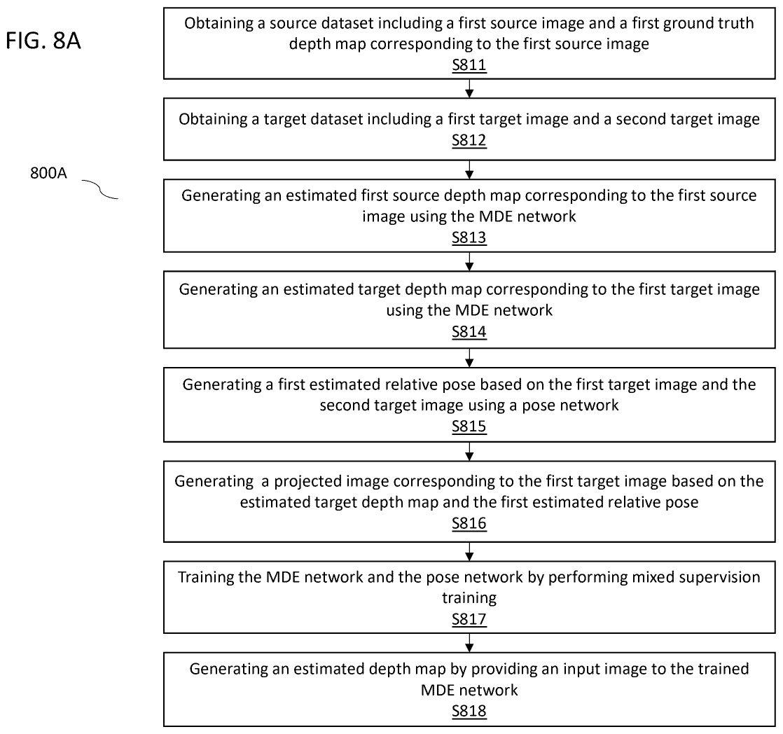

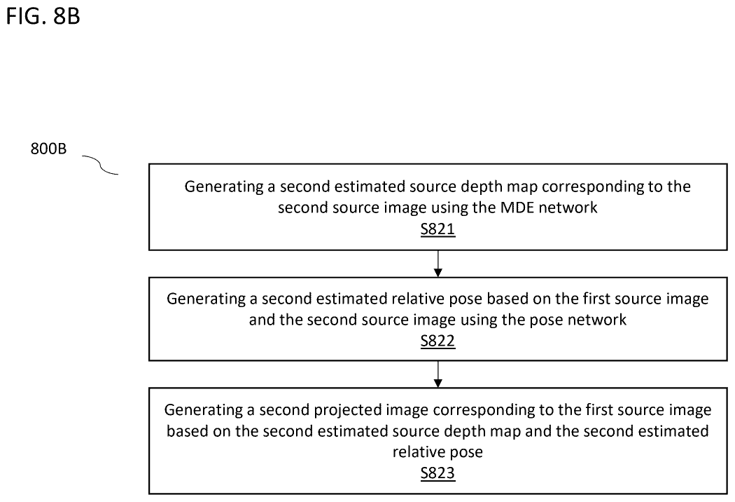

FIG. 8A is a flowchart of an example process 800A for training an MDE network and performing MDE, according to embodiments. In some implementations, one or more process blocks of FIG. 8A may be performed by any of the elements discussed above, for example one or more of the image processing system 200, the MDE network 230, the pose network 235, the training module 240, and the FOV module 245.

As shown in FIG. 8A, at operation S811 the process 800A may include obtaining a source dataset including a first source image and a first ground truth depth map corresponding to the first source image. In embodiments, the source dataset may correspond to the at least one of the source images 600 and the ground truth depth maps 610, or the converted source images 621 and the converted depth maps 611 discussed above.

As further shown in FIG. 8A, at operation S812 the process 800A may include obtaining a target dataset including a first target image and a second target image. In embodiments, the target dataset may correspond to the target images 622 discussed above.

As further shown in FIG. 8A, at operation S813 the process 800A may include generating an estimated first source depth map corresponding to the first source image using the MDE network. In embodiments, the MDE network may correspond to the MDE network 230 discussed above, and the estimated first source depth map may correspond to the estimated depth maps 650 discussed above.

As further shown in FIG. 8A, at operation S814 the process 800A may include generating an estimated target depth map corresponding to the target image using the MDE network. In embodiments, the MDE network may correspond to the MDE network 230 discussed above, and the estimated target depth map may correspond to the estimated depth maps 650 discussed above.

As further shown in FIG. 8A, at operation S815 the process 800A may include generating a first estimated relative pose based on the first target image and the second target image using a pose network. In embodiments, the first estimated relative pose may be generated by providing the first target image and the second target image to the pose network. In embodiments, the pose network may correspond to the pose network 235 discussed above, and the first estimated relative pose may correspond to the estimated relative poses 630 discussed above.

As further shown in FIG. 8A, at operation S816 the process 800 may include generating a projected image based on the estimated target depth map and the first estimated relative pose.

As further shown in FIG. 8A, at operation S817 the process 800A may include training the MDE network and the pose network by performing a mixed supervision training process. In embodiments, the mixed supervision training process may include performing fully-supervised training based on the estimated first source depth map and the first ground truth depth map, and performing self-supervised training based on the estimated target depth map and the first estimated relative pose, or for example based on the first target image and the projected image.

As further shown in FIG. 8A, at operation S818 the process 800A may include performing MDE at an inference time by providing an input image to the trained MDE network. In embodiments, operation S817 may include generating an estimated depth map which may include an absolute depth prediction corresponding to the input image.

In embodiments, the source dataset may include a plurality of source images in a source domain, and the target dataset may include a plurality of target images in a target domain. The plurality of source images may be captured using a first sensor, and the plurality of target images may be captured using a second sensor different from the first sensor.

In embodiments, the FOV of the plurality of source images may be different from a FOV of the plurality of target images, and the process 800A may further include performing FOV conversion on the plurality of source images to generate a plurality of converted source images such that a FOV of the plurality of converted source images matches the FOV of the plurality of target images.

In embodiments, the process 800A may further include training the MDE network to predict depth properties of the target domain based on depth properties of the source domain using the mixed supervision training.

In embodiments, after the mixed supervision training is performed, the process 800A may further include generating an absolute depth prediction on an input image included in the target domain using the MDE network.

In embodiments, the plurality of ground truth depth maps may be obtained using at least one from among a light detection and ranging (LiDAR) sensor, a radar sensor, a stereo camera, an infrared sensor, an ultrasonic sensor, and a time-of-flight sensor.

FIG. 8B is a flowchart of an example process 800B for training an MDE network and performing MDE, according to embodiments. In some implementations, one or more process blocks of FIG. 8B may be performed by any of the elements discussed above, for example one or more of the image processing system 200, the MDE network 230, the pose network 235, the training module 240, and the FOV module 245.

In embodiments, the source dataset may further include a second source image and a second ground truth depth map corresponding to the second source image. As shown in FIG. 8B, at operation S821 the process 800B may include generating a second estimated source depth map corresponding to the second source image using the MDE network.

As further shown in FIG. 8B, at operation S822 the process 800B may include generating a second estimated relative pose based on the first source image and the second source image using the pose network.

As further shown in FIG. 8B, at operation S823 the process 800B may include generating a second projected image corresponding to the first source image based on the second estimated source depth map and the second estimated relative pose. In embodiments, the mixed supervision training may further include performing the self-supervised training based on the second estimated source depth map and the second estimated relative pose.

Although FIGS. 8A-8B shows example blocks of processes 800A and 800B, in some implementations, the processes 800A and 800B may include additional blocks, fewer blocks, different blocks, or differently arranged blocks than those depicted in processes 800A and 800B. Additionally, or alternatively, two or more of the blocks of the processes 800A and 800B may be arranged or combined in any order, or performed in parallel.

Accordingly, embodiments may relate to a mixed supervision training process which may transfer a variety of depth properties, such as accurate predictions around object edges (e.g., sharp-edged depth maps) and absolute depth predictions, from a labeled source domain to an unlabeled target domain. The mixed supervision training process may receive as inputs unlabeled target images and labeled source images, and may convert or align the FOV of the source images to the target images. The converted source images, the corresponding converted labels, and the target images may be used to train any depth estimation model using mixed supervision training to predict depth maps. For example, the mixed supervision training may be used to train a depth estimation model (e.g., the MDE network 230) to predict depth properties of the target domain based on depth properties of the source domain. As a result, after the mixed supervision training is performed, the depth estimation model may be capable of generating absolute depth predictions based on an input image from the target domain by learning depth properties of the source domain. The input data from the source domain may be real or synthetic, may have dense or sparse ground-truth values, and may be collected using different sensors with respect to the target data.

As is traditional in the field, the embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the present scope. Further, the blocks, units and/or modules of the embodiments may be physically combined into more complex blocks, units and/or modules without departing from the present scope.

The various operations of methods described above may be performed by any suitable means capable of performing the operations, such as various hardware and/or software component(s), circuits, and/or module(s).

The software may include an ordered listing of executable instructions for implementing logical functions, and can be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

The foregoing is illustrative of certain embodiments and is not to be construed as limiting thereof. Although a few embodiments have been described, those skilled in the art will readily appreciate that many modifications are possible in the embodiments without materially departing from the present scope.

What is claimed is:

1. A method for training a monocular depth estimation (MDE) network, the method comprising:
obtaining a source dataset comprising a first source image and a first ground truth depth map corresponding to the first source image;
obtaining a target dataset comprising a first target image and a second target image;
generating an estimated first source depth map corresponding to the first source image using the MDE network;
generating an estimated target depth map corresponding to the first target image using the MDE network;
generating a first estimated relative pose based on the first target image and the second target image using a pose network; and
training the MDE network and the pose network by performing mixed supervision training,
wherein the performing the mixed supervision training comprises performing fully-supervised training based on the estimated first source depth map and the first ground truth depth map, and performing self-supervised training based on the estimated target depth map and the first estimated relative pose.

2. The method of claim 1, wherein the first estimated relative pose is generated by providing the first target image and the second target image to the pose network.

3. The method of claim 1, wherein the training further comprises:
generating a projected image corresponding to the first target image based on the estimated target depth map and the first estimated relative pose; and
performing the self-supervised training based on the first target image and the projected image.

4. The method of claim 1, wherein the source dataset further comprises a second source image and a second ground truth depth map corresponding to the second source image,
wherein the method further comprises:
generating a second estimated source depth map corresponding to the second source image using the MDE network;
generating a second estimated relative pose based on the first source image and the second source image using the pose network; and
generating a second projected image corresponding to the first source image based on the second estimated source depth map and the second estimated relative pose, and
wherein the mixed supervision training further comprises performing the self-supervised training based on the second estimated source depth map and the second estimated relative pose.

5. The method of claim 1, wherein the training comprises calculating an overall loss corresponding to a training image from one of the source dataset and the target dataset,
wherein the overall loss is expressed according to:
$${ℒ}_{total} = {ℒ}_{s e l f} + {αμℒ}_{sup} ,$$
wherein [symbol] ₜₒₜₐₗ denotes the overall loss, [symbol] _{self} denotes a self-supervised loss corresponding to the self-supervised training, and [symbol] ₛᵤₚ denotes a fully-supervised loss corresponding to the fully-supervised training, and
wherein μ is equal to one based on a ground truth depth map corresponding to the training image being used in the training, and is otherwise equal to zero.

6. The method of claim 1, wherein the source dataset comprises a plurality of source images in a source domain, and wherein the target dataset comprises a plurality of target images in a target domain,
wherein the plurality of source images are captured using a first sensor, and
wherein the plurality of target images are captured using a second sensor different from the first sensor.

7. The method of claim 6, wherein a field of view (FOV) of the plurality of source images is different from a FOV of the plurality of target images, and
wherein the method further comprises performing FOV conversion on the plurality of source images to generate a plurality of converted source images such that a FOV of the plurality of converted source images matches the FOV of the plurality of target images.

8. The method of claim 7, wherein the mixed supervision training comprises training the MDE network to predict depth properties of the target domain based on depth properties of the source domain.

9. The method of claim 8, wherein after the mixed supervision training is performed, the method further comprises generating an absolute depth prediction on an input image included in the target domain using the MDE network.

10. The method of claim 1, wherein the first ground truth depth map is obtained using at least one from among a light detection and ranging (LiDAR) sensor, a radar sensor, a stereo camera, an infrared sensor, an ultrasonic sensor, and a time-of-flight sensor.

11. The method of claim 1, wherein the first source image is a synthetic image, and
wherein the first ground truth depth map is a synthetic depth map.

12. A method of performing monocular depth estimation (MDE), the method comprising:
obtaining an input image; and
generating an estimated depth map by providing the input image to an MDE network,
wherein a training process for the MDE network comprises:
obtaining a source dataset comprising a first source image and a first ground truth depth map corresponding to the first source image;
obtaining a target dataset comprising a first target image and a second target image;
generating an estimated first source depth map corresponding to the first source image using the MDE network;
generating an estimated target depth map corresponding to the first target image using the MDE network;
generating a first estimated relative pose based on the first target image and the second target image using a pose network; and
training the MDE network and the pose network by performing mixed supervision training,
wherein the performing the mixed supervision training comprises performing fully-supervised training based on the estimated first source depth map and the first ground truth depth map, and performing self-supervised training based on the estimated target depth map and the first estimated relative pose.

13. The method of claim 12, wherein the first estimated relative pose is generated by providing the first target image and the second target image to the pose network.

14. The method of claim 12, wherein the training process further comprises:
generating a projected image based on the estimated target depth map and the first estimated relative pose; and
performing the self-supervised training based on the first target image and the projected image.

15. The method of claim 12, wherein the source dataset further comprises a second source image and a second ground truth depth map corresponding to the second source image,
wherein the training process further comprises:
generating a second estimated source depth map corresponding to the second source image using the MDE network;
generating a second estimated relative pose based on the first source image and the second source image using the pose network; and
generating a second projected image corresponding to the first source image based on the second estimated source depth map and the second estimated relative pose, and
wherein the mixed supervision training further comprises performing the self-supervised training based on the second estimated source depth map and the second estimated relative pose.

16. The method of claim 12, wherein the training process further comprises calculating an overall loss corresponding to a training image from one of the source dataset and the target dataset,
wherein the overall loss is expressed according to:
$${ℒ}_{total} = {ℒ}_{s e l f} + {αμℒ}_{sup} ,$$
wherein [symbol] ₜₒₜₐₗ denotes the overall loss, [symbol] _{self} denotes a self-supervised loss corresponding to the self-supervised training, and [symbol] ₛᵤₚ denotes a fully-supervised loss corresponding to the fully-supervised training, and
wherein μ is equal to one based on a ground truth depth map corresponding to the training image being used in the training, and is otherwise equal to zero.

17. The method of claim 12, wherein the source dataset comprises a plurality of source images in a source domain, and the target dataset comprises a plurality of target images in a target domain,
wherein the plurality of source images are captured using a first sensor, and
wherein the plurality of target images are captured using a second sensor different from the first sensor.

18. The method of claim 17, wherein a field of view (FOV) of the plurality of source images is different from a FOV of the plurality of target images, and
wherein the training process further comprises performing FOV conversion on the plurality of source images to generate a plurality of converted source images such that a FOV of the plurality of converted source images matches the FOV of the plurality of target images.

19. The method of claim 18, wherein the training process comprises training the MDE network to predict depth properties of the target domain based on depth properties of the source domain using the mixed supervision training.

20. The method of claim 19, wherein the input image is included in the target domain, and
wherein after the mixed supervision training is performed, the method further comprises generating an absolute depth prediction on the input image using the MDE network.

21. The method of claim 12, wherein the first ground truth depth map is obtained using at least one from among a light detection and ranging (LiDAR) sensor, a radar sensor, a stereo camera, an infrared sensor, an ultrasonic sensor, and a time-of-flight sensor.

22. The method of claim 12, wherein the first source image is a synthetic image, and
wherein the first ground truth depth map is a synthetic depth map.

23. A device for training a monocular depth estimation (MDE) network, the device comprising:
an MDE network configured to generate an estimated depth map based on an input image;
a pose network configured to estimate a relative pose corresponding to one input image with respect to another input image; and
a training module configured to:
obtain a source dataset comprising a first source image and a first ground truth depth map corresponding to the first source image,
obtain a target dataset comprising a first target image and a second target image,
generate an estimated first source depth map corresponding to the first source image using the MDE network,
generate an estimated target depth map corresponding to the first target image using the MDE network,
generate a first estimated relative pose based on the first target image and the second target image using the pose network, and
train the MDE network and the pose network by performing mixed supervision training including fully-supervised training based on the estimated first source depth map and the first ground truth depth map, and self-supervised training based on the estimated target depth map and the first estimated relative pose.

24. The device of claim 23, wherein the first estimated relative pose is generated by providing the first target image and the second target image to the pose network.

25. The device of claim 23, wherein the training module is further configured to:
generate a projected image based on the estimated target depth map and the first estimated relative pose; and
perform the self-supervised training based on the first target image and the projected image.

26. The device of claim 23, wherein the source dataset further comprises a second source image and a second ground truth depth map corresponding to the second source image,
wherein the training module is further configured to:
generate a second estimated source depth map corresponding to the second source image using the MDE network,
generate a second estimated relative pose based on the first source image and the second source image using the pose network, and
generate a second projected image corresponding to the first source image based on the second estimated source depth map and the second estimated relative pose, and
wherein the mixed supervision training further comprises performing the self-supervised training based on the second estimated source depth map and the second estimated relative pose.

27. The device of claim 23, wherein the training module is further configured to calculate an overall loss corresponding to a training image from one of the source dataset and the target dataset,
wherein the overall loss is expressed according to:
$${ℒ}_{total} = {ℒ}_{s e l f} + {αμℒ}_{sup} ,$$
wherein [symbol] ₜₒₜₐₗ denotes the overall loss, [symbol] _{self} denotes a self-supervised loss corresponding to the self-supervised training, and [symbol] ₛᵤₚ denotes a fully-supervised loss corresponding to the fully-supervised training, and
wherein μ is equal to one based on a ground truth depth map corresponding to the training image being used in the mixed supervision training, and is otherwise equal to zero.

28. The device of claim 23, wherein the source dataset comprises a plurality of source images in a source domain, and the target dataset comprises a plurality of target images in a target domain,
wherein the plurality of source images are captured using a first sensor, and
wherein the plurality of target images are captured using a second sensor different from the first sensor.

29. The device of claim 28, wherein a field of view (FOV) of the plurality of source images is different from a FOV of the plurality of target images, and
wherein the training module is further configured to perform FOV conversion on the plurality of source images to generate a plurality of converted source images such that a FOV of the plurality of converted source images matches the FOV of the plurality of target images.

30. The device of claim 29, wherein to perform the mixed supervision training, the training module is further configured to train the MDE network to predict depth properties of the target domain based on depth properties of the source domain.

31. The device of claim 30, wherein the input image is included in the target domain, and
wherein after the mixed supervision training is performed, the MDE network is further configured to generate an absolute depth prediction on the input image.

32. The device of claim 23, wherein the first ground truth depth map is obtained using at least one from among a light detection and ranging (LiDAR) sensor, a radar sensor, a stereo camera, an infrared sensor, an ultrasonic sensor, and a time-of-flight sensor.

33. The device of claim 23, wherein the first source image is a synthetic image, and
wherein the first ground truth depth map is a synthetic depth map.
